(19) United States
(12) Patent Application Publication
(10) Pub. No.: US 2014/0033724 A1
(43) Pub. Date: Feb. 6, 2014

(54) FUEL NOZZLE ASSEMBLY AND METHODS OF ASSEMBLING SAME

(71) Applicants: Elias Marquez, Queretaro (MX); Lucas John Stoia, Taylors, SC (US); Oscar Flores, Queretaro (MX)

(72) Inventors: Elias Marquez, Queretaro (MX); Lucas John Stoia, Taylors, SC (US); Oscar Flores, Queretaro (MX)

(21) Appl. No.: 13/566,506

(22) Filed: Aug. 3, 2012

(51) Int. Cl. F02C 7/22; B21D 51/16; B05B 1/00

(52) U.S. Cl. 60/740; 239/589; 29/890.09

(57) ABSTRACT

A fuel nozzle assembly for use with a turbine engine is provided. The fuel nozzle assembly includes a tube assembly that includes a plurality of openings, wherein the tube assembly is configured to channel at least a first type of fuel through the turbine engine. A plurality of fasteners are removably coupled to the tube assembly such that each of the fasteners are severally removable from the tube assembly to enable a plurality of different types of fuel to be channeled through the turbine engine for operation of the turbine engine.

### BACKGROUND OF THE INVENTION

The field of the invention relates generally to turbine engines and, more particularly, to a fuel nozzle assembly for use with turbine engines.

At least some known turbine engines, such as gas turbine engines, are used in cogeneration facilities and power plants to generate power. At least some known gas turbine engines may have high specific work and power per unit mass flow requirements. To increase the operating efficiency, gas turbine engines may operate with increased combustion temperatures. Moreover, in at least some known gas turbine engines, engine efficiency increases as combustion gas temperatures increase.

However, operating with higher temperatures may also increase the generation of polluting emissions, such as oxides of nitrogen (NO_{X}). In an attempt to reduce the generation of such emissions, at least some known gas turbine engines include improved combustion system designs. For example, at least some known combustion systems may include a plurality of fuel nozzles or fuel nozzle assemblies, wherein at least one of the fuel nozzles is a pre-mix nozzle. For example, known pre-mix nozzles enable substances to be mixed, such as diluents, gases, and/or air, with fuel to generate a fuel mixture for combustion. The mixed substances are discharged from a tube of the pre-mix nozzle through a plurality of pegs or fasteners that are welded onto the pre-mix nozzle. More specifically, known pegs include a plurality of openings that enable the fuel to be discharged therefrom.

Various types of fuels may be used during operation of the gas turbine engine. However, each of the different types of fuels may require a specific size (i.e., diameter) of peg openings. For example, while the peg openings may be sufficient for the passage of one type of fuel, those same openings may be too large or too small for a different type of fuel. As such, the pegs of the pre-mix nozzle may need to be changed based on the type of fuel being used. However, in order to replace the pegs, the attached pegs may need to be cut from the nozzle and then new pegs may need to be welded onto the nozzle. Such a process may be very time consuming and/or labor intensive or be relatively challenging.

### BRIEF DESCRIPTION OF THE INVENTION

In one embodiment, a fuel nozzle assembly for use with a turbine engine is provided. The fuel nozzle assembly includes a tube assembly that includes a plurality of openings, wherein the tube assembly is configured to channel at least a first type of fuel through the turbine engine. A plurality of fasteners are removably coupled to the tube assembly such that each of the fasteners are severally removable from the tube assembly to enable a plurality of different types of fuel to be channeled through the turbine engine for operation of the turbine engine.

In another embodiment, a turbine engine is provided. The turbine engine includes a compressor. A combustion assembly is coupled to the compressor and the combustion assembly includes at least one combustor. At least one fuel nozzle assembly is coupled within the combustor. The fuel nozzle assembly includes a tube assembly that includes a plurality of openings, wherein the tube assembly is configured to channel at least a first type of fuel through the turbine engine. A plurality of fasteners are removably coupled to the tube assembly such that each of the fasteners are severally removable from the tube assembly to enable a plurality of different types of fuel to be channeled through the turbine engine for operation of the turbine engine.

In yet another embodiment, a method of assembling a fuel nozzle assembly for use with a turbine engine is provided. A tube assembly that includes a plurality of openings is provided, wherein the tube assembly is configured to channel at least a first type of fuel through the turbine engine. A plurality of fasteners are coupled to the tube assembly to enable the first type of fuel to be channeled through the turbine engine. Each of the fasteners are removed from the tube assembly to enable a plurality of different types of fuel to be channeled through the turbine engine for operation of the turbine engine.

### BRIEF DESCRIPTION OF THE DRAWINGS

FIG. 1 is schematic cross-sectional view of an exemplary turbine engine;

FIG. 2 is a perspective view of a portion of an exemplary fuel nozzle assembly that may be used with the turbine engine shown in FIG. 1 and taken from area 2;

FIG. 3 is a cross-sectional view of a portion of the fuel nozzle assembly shown in FIG. 2 and taken from area 3;

FIG. 4 is a perspective view of an alternative fuel nozzle assembly that may be used with the turbine engine shown in FIG. 1 and taken from area 2;

FIG. 5 is a cross-sectional view of a portion of the fuel nozzle assembly shown in FIG. 4 and taken from area 5;

FIG. 6 is a schematic of a portion of the fuel nozzle assembly shown in FIG. 5 and taken from area 6;

FIG. 7 is a perspective view of an alternative fuel nozzle assembly that may be used with the turbine engine shown in FIG. 1 and taken from area 2; and

FIG. 8 is a cross-sectional view of a portion of the fuel nozzle assembly shown in FIG. 7 and taken from area 8.

### DETAILED DESCRIPTION OF THE INVENTION

The exemplary apparatus, systems, and methods described herein overcome at least some known disadvantages associated with at least some known combustion systems of turbine engines. More specifically, the embodiments described herein provide a fuel nozzle assembly that includes components that may be relatively easily and efficiently removed and/or replaced for the various types of fuels being used with the turbine engine. For example, the fuel nozzle assembly includes a plurality of fasteners that are removably coupled to a tube of the fuel nozzle assembly such that each of the fasteners are severally removable from the tube to enable a plurality of different types of fuel to be channeled through the turbine engine for operation of the turbine engine. Accordingly, in order to replace the attached fasteners, they no longer need to be cut from the nozzle and welding may not be required for attaching the new fasteners.

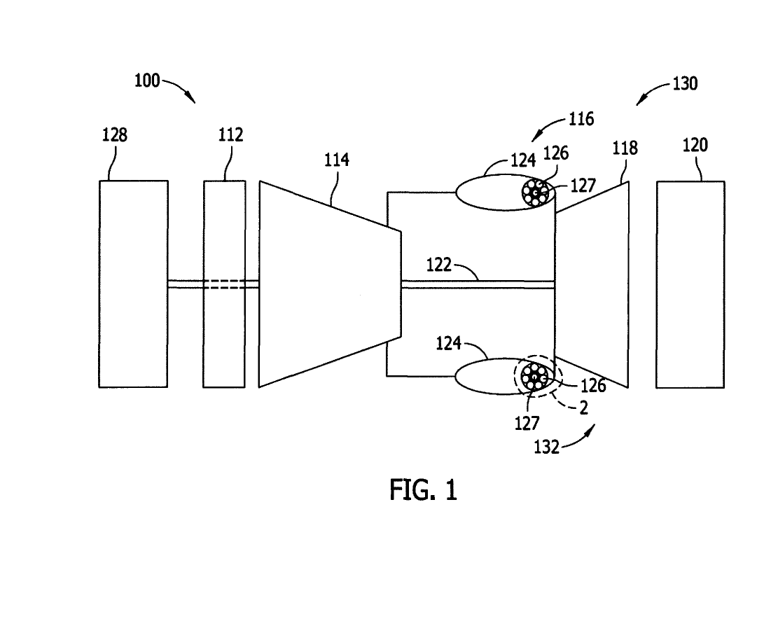

FIG. 1 illustrates an exemplary turbine engine 100. More specifically, in the exemplary embodiment, turbine engine 100 is a gas turbine engine. While the exemplary embodiment illustrates a gas turbine engine, the present invention is not limited to any particular engine, and one of ordinary skill in the art will appreciate that the current invention may be used in connection with other turbine engines.

Moreover, in the exemplary embodiment, turbine engine 100 includes an intake section 112, a compressor section 114 coupled downstream from intake section 112, a combustor section 116 coupled downstream from compressor section 114, a turbine section 118 coupled downstream from combustor section 116, and an exhaust section 120. It should be noted that, as used herein, the term “couple” is not limited to a direct mechanical, thermal, communication, and/or an electrical connection between components, but may also include an indirect mechanical, thermal, communication and/or electrical connection between multiple components.

In the exemplary embodiment, turbine section 118 is coupled to compressor section 114 via a rotor shaft 122. Combustor section 116 includes a plurality of combustors 124. Combustor section 116 is coupled to compressor section 114 such that each combustor 124 is positioned in flow communication with the compressor section 114. A plurality of fuel nozzles, such as fuel nozzles 126 and fuel nozzle 127, are coupled within each combustor 124. In the exemplary embodiment, fuel nozzles 126 are diffusion type nozzles and fuel nozzle 127 is a pre-mix fuel nozzle. Alternatively, fuels nozzles 126 and 127 may be any suitable fuel nozzle that enables turbine engine 100 to function as described herein. Moreover, fuel nozzles 126 and 127 may be aligned substantially within a cap member (not shown) and/or fuel nozzles 126 and 127 may be integrally formed with the cap member.

In the exemplary embodiment, fuel nozzles 126 are spaced circumferentially about fuel nozzle 127 such that fuel nozzle 127 is positioned within the center of the cap member. Alternatively, fuel nozzles 126 and 127 may be oriented in any orientation that enables turbine engine 100 to function as described herein. Moreover, as described in more detail below, fuel nozzle 127 includes a fuel nozzle assembly (not shown in FIG. 1) that includes components (not shown in FIG. 1) that can be relatively easily and efficiently removed and/or replaced from fuel nozzle 127. In the exemplary embodiment, while only fuel nozzle 127 includes the fuel nozzle assembly, the other nozzles 126 may also include the fuel nozzle assembly.

Further, in the exemplary embodiment, turbine section 118 is coupled to compressor section 114 and to a load 128 such as, but not limited to, an electrical generator and/or a mechanical drive application. In the exemplary embodiment, each compressor section 114 and turbine section 118 includes at least one rotor disk assembly 130 that is coupled to a rotor shaft 122 to form a rotor assembly 132.

During operation, intake section 112 channels air towards compressor section 114 wherein the air is compressed to a higher pressure and temperature prior to being discharged towards combustor section 116. The compressed air is mixed with fuel and other fluids that are ignited to generate combustion gases that are channeled towards turbine section 118. More specifically, fuel, such as natural gas and/or fuel oil, air, diluents, and/or Nitrogen gas (N₂) may be channeled into combustors 124, into the air flow, and into at least fuel nozzle 127. The blended mixtures are ignited to generate high temperature combustion gases that are channeled towards turbine section 118. Turbine section 118 converts the thermal energy from the gas stream to mechanical rotational energy, as the combustion gases impart rotational energy to turbine section 118 and to rotor assembly 132.

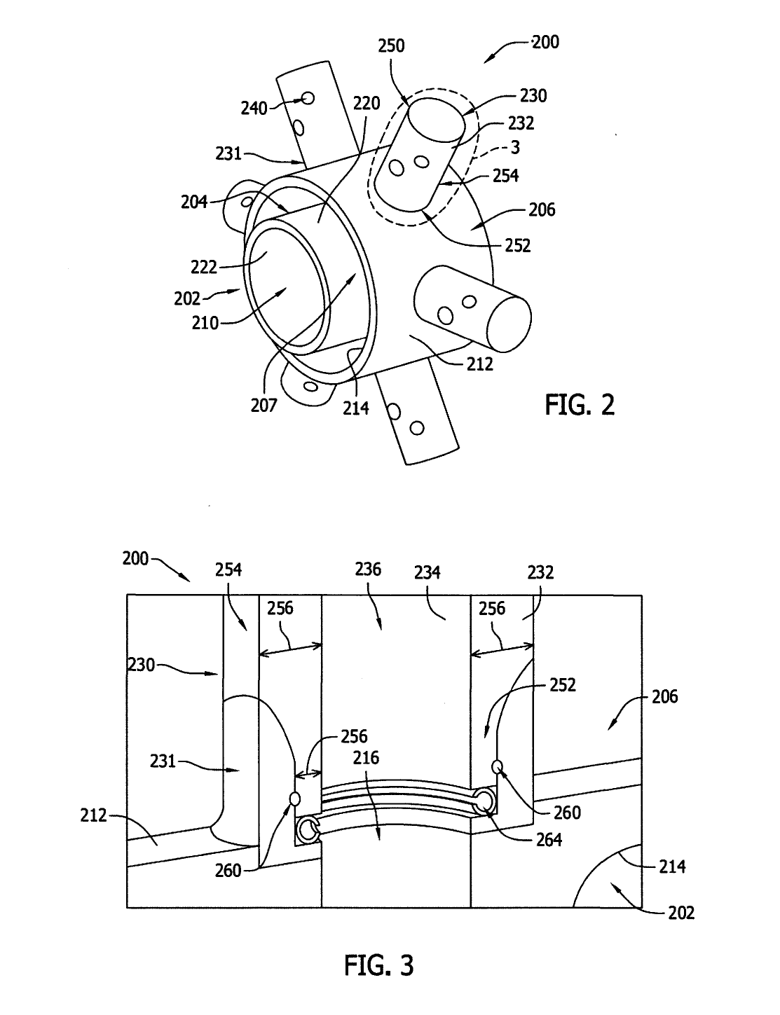

FIG. 2 is a perspective view of an exemplary fuel nozzle assembly 200 that may be used with turbine engine 100 (shown in FIG. 1) and taken from area 2 (shown in FIG. 1). FIG. 3 is a cross-sectional view of a portion of fuel nozzle assembly 200 and taken from area 3 (shown in FIG. 2). Fuel nozzle assembly 200 includes a cylindrical tube assembly 202 that includes an inner cylindrical tube 204 and an outer cylindrical tube 206. More specifically, in the exemplary, outer tube 206 includes a channel 207 defined therein and inner tube 204 is positioned within channel 207. Inner tube 204 includes a channel 210 such that fluids, such as various types of fuels, may be channeled therethrough.

In the exemplary embodiment, outer tube 206 includes an exterior surface 212, an opposing interior surface 214, and a plurality of openings 216 that extend from exterior surface 212 and interior surface 214. Similarly, inner tube 204 includes an exterior surface 220, an opposing interior surface 222, and a plurality of openings (not shown) that extend from exterior surface 220 to interior surface 222. In the exemplary embodiment, openings 216 of the outer tube 206 are concentrically aligned with the openings of inner tube 204. Moreover, in the exemplary embodiment, tube assembly 202 includes a plurality of small cylindrical tube members (not shown) that each extend from each inner tube opening to each outer tube opening 216. Each tube member has a channel (not shown) defined therein such that fluids, such as various types of fuels, may be channeled therethrough. More specifically, fluid may be channeled from channel 210 and through the inner cylindrical tube opening. The fluid is then channeled through the channel in the small tube member and through each outer tube opening 216.

In the exemplary embodiment, outer tube 206, inner tube 204, and the tube members are integrally formed together such that tube assembly 202 is a unitary component. Alternatively, outer tube 206, inner tube 204, and the tube members may be separate structures that are coupled together. Moreover, tube assembly 202 may be formed via a variety of manufacturing processes known in the art, such as, but not limited to, molding process, drawing process or a machining process. One or more types of materials may be used to fabricate tube assembly 202 with the materials selected based on suitability for one or more manufacturing techniques, dimensional stability, cost, moldability, workability, rigidity, and/or other characteristic of the material(s). For example, tube assembly 202 may be fabricated from steel.

Further, in the exemplary embodiment, fuel nozzle assembly 200 includes a plurality of fasteners 230 that are removably coupled to tube assembly 202. More specifically, fasteners 230 are coupled to a plurality of coupling portions 231 that are coupled directly to exterior surface 212 of outer tube 206. In the exemplary embodiment, each fastener 230 is coupled to coupling portions 231 such that each fastener 230 extends radially outwardly from exterior surface 212 and such that fasteners 230 are concentrically aligned with outer tube openings 216 and the inner tube openings. Moreover, in the exemplary embodiment, each fastener 230 is substantially cylindrical. Alternatively, each fastener 230 may be any suitable shape that enables fuel nozzle assembly 200 and/or turbine engine 100 to function as described herein.

In the exemplary embodiment, each fastener 230 includes an exterior portion 232 and an interior portion 234 that has a channel 236 defined therein such that fluids, such as various types of fuels, may be channeled therethrough. Moreover, in the exemplary embodiment, each fastener 230 has a plurality of openings 240 that extend from exterior portion 232 to interior portion 234. As such, fluid may be channeled through channel 236 and through openings 240 for use within combustor 124 (shown in FIG. 1). In the exemplary embodiment, openings 240 have a predefined size (e.g., diameter) suitable for enabling specific types of fluids to be channeled therethrough.

Each coupling portion 231, in the exemplary embodiment, is configured to receive one fastener 230 via snap-fit engagement. More specifically, in the exemplary embodiment, each fastener 230 has a first end portion 250, a second end portion 252, and a middle portion 254 that extends therebetween. There is a predefined distance 256 from exterior portion 232 to interior portion 234. However, each fastener 230 is configured to slightly change distance 256 to couple to coupling portion 231. For example, second end portion 252 is configured to slide within and be positioned within coupling portion 231. When second end portion 252 is positioned within coupling portion 231, distance 256 from exterior portion 232 and interior portion 234 in second end portion 252 becomes substantially less than distance 256 in first end portion 250 and in middle portion 254. Further, when second end portion 252 is positioned within coupling portion 231 coupling portion 231 substantially circumscribes at least a portion of second end portion 252. Locking members 260 are positioned between a portion of second end portion 252 and a portion of coupling portion 231 to secure fastener 230 to tube assembly 202. Moreover, a seal 264 is positioned within coupling portion 231 and positioned against second end portion 252 such that fluid flow is substantially prevented from leaking from within fastener 230. When second end portion 252 is removed from coupling portion 231, then distance 256 in second end portion 252 is substantially proportional to distance 256 in first end portion 250 and in middle portion 254.

In the exemplary embodiment, fastener 230 may be formed of any suitable material that facilitates a deformation of fasteners 230 for the snap-fit engagement described above. Moreover, fasteners 230, coupling portions 231, and/or tube assembly 202 may all be fabricated from the same material that enables fuel nozzle assembly 200 and/or turbine engine 100 to function as described herein. Alternatively, fasteners 230, coupling portions 231, and/or tube assembly 202 may each be fabricated from different materials that enables fuel nozzle assembly 200 and/or turbine engine 100 to function as described herein.

Prior to operation of turbine engine 100, fasteners 230 may be coupled to tube assembly 202. More specifically, second end portion 252 of each fastener 230 may be inserted within coupling portion 231 and snapped-on such that fastener 230 is securely coupled to tube assembly 202. Operation of turbine engine 100 may then begin. More specifically, fuel, such as natural gas and/or fuel oil, air, diluents, and/or Nitrogen gas (N₂) is channeled into fuel nozzle 127 and into fuel nozzle assembly 200. In the exemplary embodiment, fuel may be channeled from channel 210 of inner tube 204, through the inner tube opening, and through the channel in the small tube member. Then the fuel may be channeled through each outer tube opening 216 and into channel 236 of each fastener 230. The fuel is then discharged through fastener openings 240 such that the fuel may be ignited to generate high temperature combustion gases that are channeled towards turbine section 118 (shown in FIG. 1). Moreover, when fastener 230 is coupled to tube assembly 202, fastener openings 240 are aligned such that openings 240 point downstream with respect to channel 210 and openings 240 have an axis (not shown) that is substantially parallel to channel 210.

A user of turbine engine 100 may change the type of fuel being used with turbine engine 100. However, the new type of fuel may not fit through fastener openings 240. As such, the user may remove each of the fasteners 230 from tube assembly 202. More specifically, each fastener 230 may snap-off of coupling portion 231 and be replaced with different fasteners (not shown) having openings (not shown) that are suitable for the new type of fuel being used. When the different fastener is coupled to tube assembly 202, the openings of the different fastener are also aligned such that the openings also point downstream with respect to channel 210 and the openings have an axis (not shown) that is substantially parallel to channel 210. As such, misalignment of fastener openings 240 and the openings of the different fasteners are substantially prevented. In at least some known combustion systems wherein the pegs are welded on a nozzle, the welding may result in a misalignment due to human error and weld heat distortion.

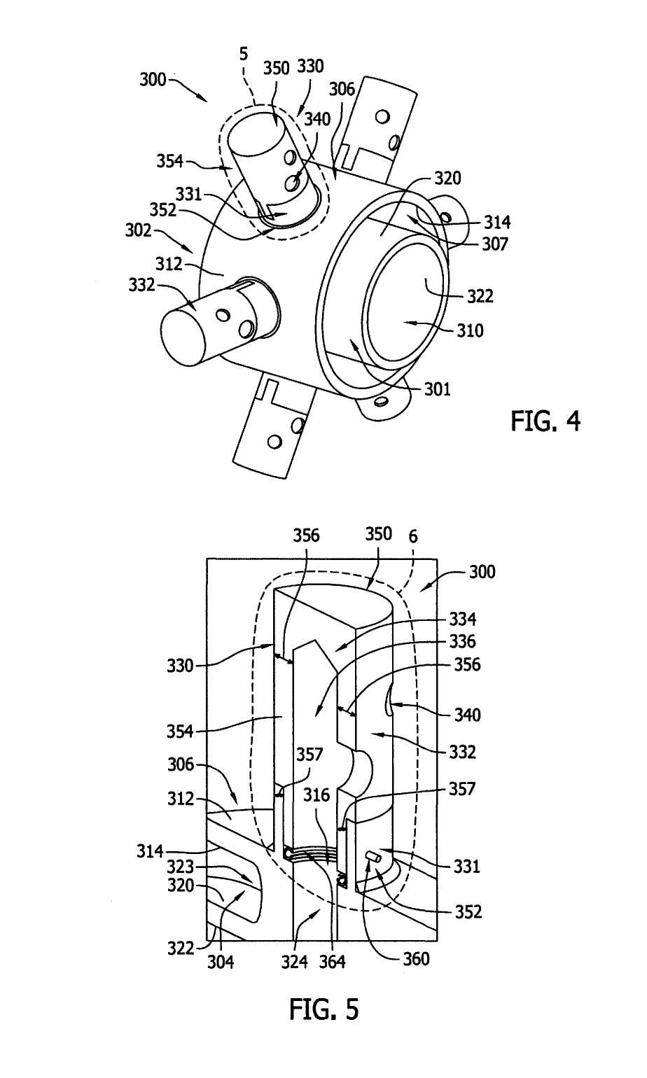

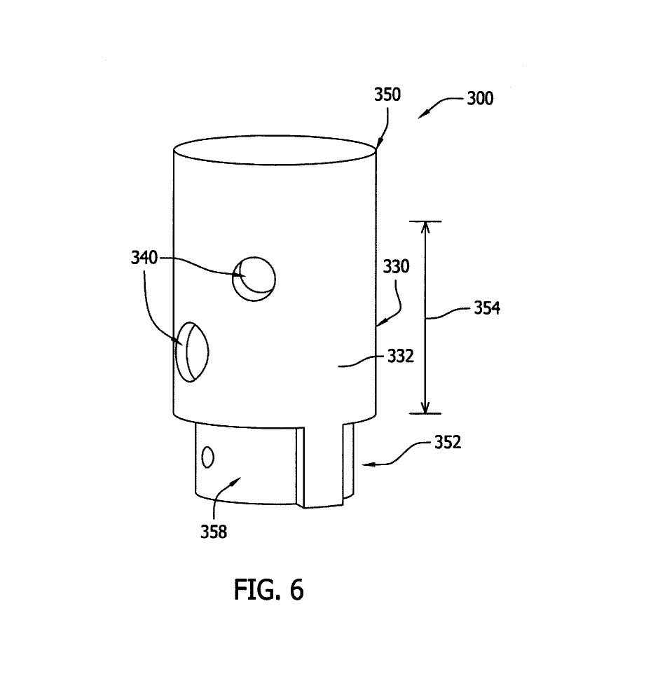

FIG. 4 is a perspective view of an alternative fuel nozzle assembly 300 that may be used with turbine engine 100 (shown in FIG. 1) in place of fuel nozzle assembly 200 (shown in FIGS. 2 and 3). FIG. 5 is a cross-sectional view of a portion of fuel nozzle assembly 300 and taken from area 5 (shown in FIG. 4). FIG. 6 is a schematic of a portion of fuel nozzle assembly 300 and taken from area 6 (shown in FIG. 5). Fuel nozzle assembly 300 includes a cylindrical tube assembly 302 that includes an inner cylindrical tube 304 and an outer cylindrical tube 306. More specifically, in the exemplary, outer tube 306 includes a channel 307 defined therein and inner tube 304 is positioned within channel 307. Inner tube 304 includes a channel 310 such that fluids, such as various types of fuels, may be channeled therethrough.

In the exemplary embodiment, outer tube 306 includes an exterior surface 312, an opposing interior surface 314, and a plurality of openings 316 that extend from exterior surface 312 to interior surface 314. Similarly, inner tube 304 includes an exterior surface 320, an opposing interior surface 322, and a plurality of openings (not shown) that extend from exterior surface 320 to interior surface 322. In the exemplary embodiment, outer tube openings 316 are concentrically aligned with the inner tube openings. Moreover, in the exemplary embodiment, tube assembly 302 includes a plurality of small cylindrical tube members 323 that each extend from each inner tube opening to each outer tube opening 316. Each small tube member 323 has a channel 324 defined therein such that fluids, such as various types of fuels, may be channeled therethrough. More specifically, fluid may be channeled from channel 310 and through the inner cylindrical tube opening. The fluid is then channeled through channel 324 in tube member 323 and through each outer tube opening 316.

In the exemplary embodiment, outer tube 306, inner tube 304, and tube members 323 are integrally formed together such that tube assembly 302 is a unitary component. Alternatively, outer tube 306, inner tube 304, and tube members 323 may be separate structures that are coupled together. Moreover, tube assembly 302 may be formed via a variety of manufacturing processes known in the art, such as, but not limited to, molding process, drawing process or a machining process. One or more types of materials may be used to fabricate tube assembly 302 with the materials selected based on suitability for one or more manufacturing techniques, dimensional stability, cost, moldability, workability, rigidity, and/or other characteristic of the material(s). For example, tube assembly 302 may be fabricated from steel.

Further, in the exemplary embodiment, fuel nozzle assembly 300 includes a plurality of fasteners 330 that are removably coupled to tube assembly 302. More specifically, fasteners 330 are coupled to tube assembly 302 via a plurality of coupling portions 331 that are integrally formed directly onto exterior surface 312 of outer tube 306. Each coupling portion 331 extends radially outwardly from exterior surface 312 of outer tube 306. In the exemplary embodiment, each fastener 330 is coupled to coupling portions 331 such that each fastener 330 extends radially outwardly from exterior surface 312 and such that fasteners 330 are concentrically aligned with outer tube openings 316 and the inner cylindrical tube openings. Moreover, in the exemplary embodiment, each fastener 330 is substantially cylindrical. Alternatively, each fastener 330 may be any suitable shape that enables fuel nozzle assembly 300 and/or turbine engine 100 to function as described herein. For example, each fastener 330 may include, but is not limited to, aerodynamics that enables a substantially thorough premix of fuel and air, and/or wherein the aerodynamics enables a desired operability and flashback and/or flame holding likelihood.

In the exemplary embodiment, each fastener 330 includes an exterior portion 332 and an interior portion 334 that has a channel 336 defined therein such that various types of fluids, such as various types of fuels, may be channeled therethrough. Moreover, in the exemplary embodiment, each fastener 330 has a plurality of openings 340 that extend from exterior portion 332 to interior portion 334. As such, fluid may be channeled through channel 336 and through openings 340 for use within combustor 124 (shown in FIG. 1). In the exemplary embodiment, openings 340 have a predefined size (e.g., diameter) suitable for enabling specific types of fluid to be channeled therethrough.

Moreover, in the exemplary embodiment, each fastener 330 has a first end portion 350, a second end portion 352, and a middle portion 354 that extends therebetween. In the exemplary embodiment, there is a predefined distance 356 from exterior portion 332 to interior portion 334 on the middle portion 354 and the first end portion 350. There is also a predefined distance 357 from exterior portion 332 to interior portion 334 on the second end portion 352. More specifically, in the exemplary embodiment, second end portion 352 includes a groove 358 such that distance 357 is substantially less than distance 356. Groove 358 enables second end portion 352 to be received within coupling portion 331 such that coupling portion 331 substantially circumscribes groove 358. Locking members 360 are positioned between groove 358 and a portion of coupling portion 331 to secure fastener 330 to tube assembly 302. In the exemplary embodiment, locking members 360 are pins. Moreover, a seal 364 is positioned within coupling portion 331 and positioned against second end portion 352 such that fluid flow is substantially prevented from leaking from within fastener 330.

In the exemplary embodiment, fasteners 330 may be formed of any suitable material, such as various types of metals. Moreover, fasteners 330, coupling portions 331, and/or tube assembly 302 may all be fabricated from the same material that enables fuel nozzle assembly 300 and/or turbine engine 100 to function as described herein. Alternatively, fasteners 330, coupling portions 331, and/or tube assembly 302 may each be fabricated from different materials that enables fuel nozzle assembly 300 and/or turbine engine 100 to function as described herein.

Prior to operation of turbine engine 100, fasteners 330 may be coupled to tube assembly 302. More specifically, second end portion 352 of each fastener 330 may be inserted within coupling portion 331 such that fastener 330 is securely coupled to tube assembly 302. Operation of turbine engine 100 may then begin. More specifically, fuel, such as natural gas and/or fuel oil, air, diluents, and/or Nitrogen gas (N₂) is channeled into fuel nozzle 127 (shown in FIG. 1) and into fuel nozzle assembly 300. In the exemplary embodiment, fuel may be channeled from channel 310 of inner tube 304, through the inner tube opening, and through channel 324 in tube member 323. Then the fuel may be channeled through each outer tube opening 316 and into channels 336 of each fastener 330. The fuel is then discharged through fastener openings 340 such that the fuel may be ignited to generate high temperature combustion gases that are channeled towards turbine section 118 (shown in FIG. 1). Moreover, when fastener 330 is coupled to tube assembly 302, fastener openings 340 are aligned such that openings 340 point downstream with respect to channel 310 and openings 340 have an axis (not shown) that is substantially parallel to channel 310.

A user of turbine engine 100 may change the type of fuel being used with turbine engine 100 and the new type of fuel may not fit through fastener openings 340. As such, user may remove each of the fasteners 330 from cylindrical tube assembly 302. More specifically, second end portion 352 of each fastener 330 may be removed from coupling portion 331 and fasteners 330 may be replaced with different fasteners (not shown) having openings (not shown) that are suitable for the new type of fuel. When the different fastener is coupled to tube assembly 302, the openings of the different fastener are also aligned such that the openings also point downstream with respect to channel 310 and the openings have an axis (not shown) that is substantially parallel to channel 310. As such, misalignment of fastener openings 340 and the openings of the different fasteners are substantially prevented.

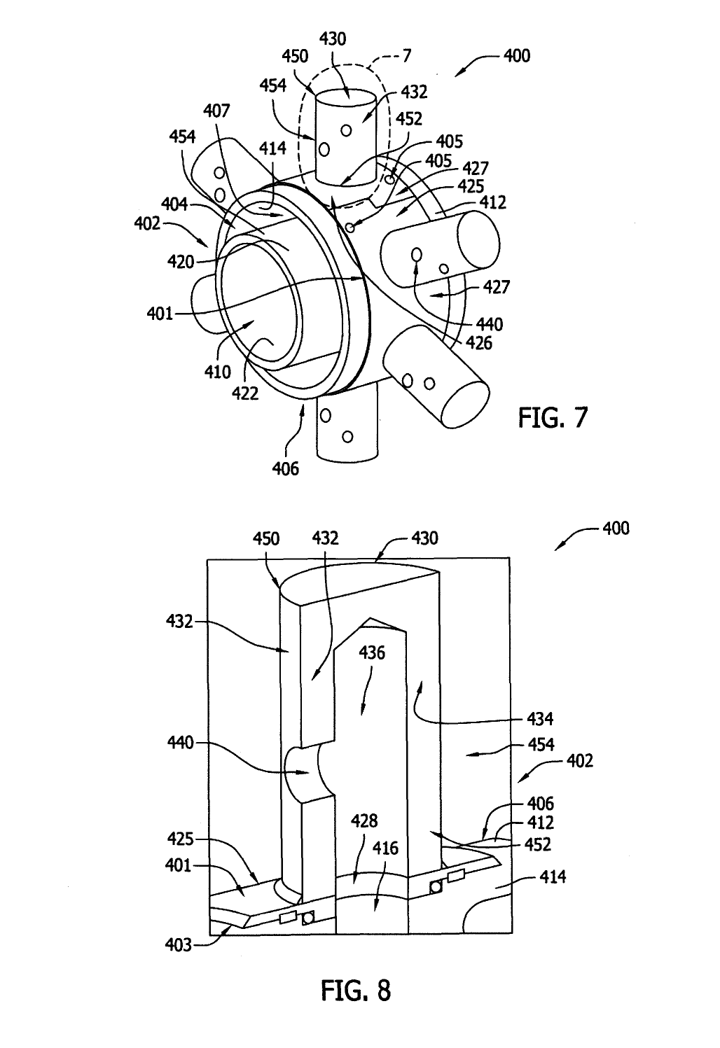

FIG. 7 is a perspective view of an alternative fuel nozzle assembly 400 that may be used with turbine engine 100 (shown in FIG. 1) in place of fuel nozzle assembly 200 (shown in FIGS. 2 and 3). FIG. 8 is a cross-sectional view of a portion of fuel nozzle assembly 400 and taken from area 8 (shown in FIG. 7). Fuel nozzle assembly 400 includes a cylindrical tube assembly 402 that includes an inner cylindrical tube 404 and an outer cylindrical tube 406. More specifically, in the exemplary, outer tube 406 includes a channel 407 defined therein and inner tube 404 is positioned within channel 407. Inner tube 404 includes a channel 410 such that fluids, such as various types of fuels, may be channeled therethrough.

In the exemplary embodiment, outer tube 406 includes an exterior surface 412, an opposing interior surface 414, and a plurality of openings 416 that extend from exterior surface 412 to interior surface 414. Similarly, inner tube 404 includes an exterior surface 420, an opposing interior surface 422, and a plurality of openings (not shown) that extend from exterior surface 420 to interior surface 422. In the exemplary embodiment, outer tube openings 416 are concentrically aligned with the inner tube openings. Moreover, in the exemplary embodiment, tube assembly 402 includes a plurality of small cylindrical tube members (not shown) that each extend from each inner tube opening to outer tube openings 416. Each tube member has a channel (not shown) defined therein such that fluids, such as various types of fuels, may be channeled therethrough. More specifically, fluid may be channeled from channel 410 and through the inner tube opening. Fluid may then be channeled through the tube member and through each outer tube opening 416.

In the exemplary embodiment, outer tube 406, inner tube 404, and the tube members are integrally formed together such that tube assembly 402 is a unitary component. Alternatively, outer tube 406, inner tube 404, and the tube members may be separate structures that are coupled together. Moreover, tube assembly 402 may be formed via a variety of manufacturing processes known in the art, such as, but not limited to, molding process, drawing process or a machining process. One or more types of materials may be used to fabricate tube assembly 402 with the materials selected based on suitability for one or more manufacturing techniques, dimensional stability, cost, moldability, workability, rigidity, and/or other characteristic of the material(s). For example, tube assembly 402 may be fabricated from steel.

Further, in the exemplary embodiment, fuel nozzle assembly 400 includes an annular attachment plate 425 that is removably coupled to tube assembly 402. More specifically, plate 425 facilitates coupling a plurality of fasteners 430 to tube assembly 402. In the exemplary embodiment, attachment plate 425 includes a first portion 426 and a second portion 427 that are coupled together to form the annular shape of plate 425 such that plate 425 substantially circumscribes exterior surface 412 of outer tube 406. At least one bolt 405 may be used to securely couple plate 425 to exterior surface 412 of outer tube 406. Alternatively, attachment plate 425 may be a single unitary structure substantially circumscribing tube assembly 402.

Moreover, in the exemplary embodiment, plate 425 includes an exterior surface 401 positioned adjacent to fasteners 430 and an opposing interior surface 403 positioned adjacent to exterior surface 412 of outer tube 406. Plate 425 also includes a plurality of openings 428 that extend from exterior surface 401 to interior surface 403. Each fastener 430 is coupled to openings 428 such that fasteners 430 are concentrically aligned with openings 428. Moreover, fasteners 430 extend radially outwardly from plate 425, and fasteners 430 and plate openings 428 are concentrically aligned with each of the outer tube openings 416 and the inner tube openings. Each fastener 430, in the exemplary embodiment, is substantially cylindrical. Alternatively, each fastener 430 may be any suitable shape that enables fuel nozzle assembly 400 and/or turbine engine 100 to function as described herein.

In the exemplary embodiment, fastener 430 may be coupled to or integrally formed to plate 425. For example, fastener 430 may be formed with plate 425 via a variety of manufacturing processes known in the art, such as, but not limited to, molding process, drawing process or a machining process. One or more types of materials may be used to fabricate plate 425 and/or fasteners 430 with the materials selected based on suitability for one or more manufacturing techniques, dimensional stability, cost, moldability, workability, rigidity, and/or other characteristic of the material(s). For example, both plate 425 and fasteners 430 may be fabricated from steel.

In the exemplary embodiment, each fastener 430 includes an exterior portion 432 and an interior portion 434 that has a channel 436 defined therein such that fluids, such as various types of fuels, may be channeled therethrough. Moreover, in the exemplary embodiment, each fastener 430 has a plurality of openings 440 that extend from exterior portion 432, through interior portion 434, and to channel 436. As such, fluid may be channeled through channel 436 and through openings 440 for use within combustor 124 (shown in FIG. 1). In the exemplary embodiment, openings 440 have a predefined size (e.g., diameter) suitable for enabling specific types of fluid to be channeled therethrough.

Moreover, in the exemplary embodiment, each fastener 430 has a first end portion 450, a second end portion 452, and a middle portion 454 that extends therebetween. In the exemplary embodiment, channel 436 extends from first end portion 450 to second end portion 452. Further, in the exemplary embodiment, second end portion 452 is adjacent to exterior surface 401 of plate 425.

Prior to operation of turbine engine 100, plate 425 with fasteners 430 may be coupled to tube assembly 402. More specifically, plate first portion 426 and plate second portion 427 are positioned on exterior surface 412 of outer tube 406 to substantially circumscribe tube 406. Bolts 405 are then used to secure plate 425 onto tube 406. Operation of turbine engine 100 may then begin. More specifically, fuel, such as natural gas and/or fuel oil, air, diluents, and/or Nitrogen gas (N₂) is channeled into fuel nozzle 127 (shown in FIG. 1) and into fuel nozzle assembly 400. In the exemplary embodiment, fuel may be channeled from channel 410 of inner tube 404 and through the inner tube opening. Fluid is then channeled through the channel in the tube member. Then the fuel may channel through outer tube opening 416 and into channel 436 of each fastener 430. The fuel is then discharged through fastener openings 440 such that the fuel may be ignited to generate high temperature combustion gases that are channeled towards turbine section 118 (shown in FIG. 1). Moreover, when fastener 430 is coupled to tube assembly 402, fastener openings 440 are aligned such that openings 440 point downstream with respect to channel 410 and openings 440 have an axis (not shown) that is substantially parallel to channel 410.

A user of turbine engine 100 may change the type of fuel being used with turbine engine 100 and the new and/or different type of fuel may not fit through fastener openings 440. As such, the user may remove each of the fasteners 430 from cylindrical tube assembly 402 and replace with different fasteners (not shown) that may be suitable for the new type of fuel. More specifically, in the exemplary embodiment, the user would remove bolts 405 and remove plate 425 from tube assembly 402. The user may replace plate 425 with a different plate (not shown) having different fasteners that are suitable for the new and/or different type of fuel and turbine engine 100. Alternatively, fasteners 430 may be removed from plate 425 and replaced with the other fasteners, and plate 425 may continue to be used with turbine engine 100. When the different fastener is coupled to tube assembly 402, the openings of the different fastener are also aligned such that the openings also point downstream with respect to channel 410 and the openings have an axis (not shown) that is substantially parallel to channel 410. As such, misalignment of fastener openings 440 and the openings of the different fasteners are substantially prevented.

As compared to known turbine engines, the embodiments described herein provide a fuel nozzle assembly that enables the use of different types of fuels by providing a relatively easy and efficient solution to removing and replacing pegs or fasteners of the fuel nozzle assembly. More specifically, the fuel nozzle includes a tube assembly that includes a plurality of openings, wherein the tube assembly is configured to channel at least a first type of fuel through the turbine engine. A plurality of fasteners are removably coupled to the tube assembly such that each of the fasteners are severally removable from the tube assembly to enable a plurality of different types of fuel to be channeled through the turbine engine for operation of the turbine engine. Accordingly, in order to replace the attached fasteners, they no longer need to be cut from the nozzle and welding may not be required for attaching the new fasteners.

Exemplary embodiments of the apparatus, systems, and methods are described above in detail. The apparatus, systems, and methods are not limited to the specific embodiments described herein, but rather, components of the apparatus, systems, and/or steps of the methods may be utilized independently and separately from other components and/or steps described herein. For example, the systems may also be used in combination with other systems and methods, and is not limited to practice with only the systems as described herein. Rather, the exemplary embodiment can be implemented and utilized in connection with many other applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A fuel nozzle assembly for use with a turbine engine, said fuel nozzle assembly comprising:
a tube assembly comprising a plurality of openings, wherein said tube assembly is configured to channel at least a first type of fuel through the turbine engine; and
a plurality of fasteners removably coupled to said tube assembly such that each of said plurality of fasteners are severally removable from said tube assembly to enable a plurality of different types of fuel to be channeled through the turbine engine for operation of the turbine engine.

2. A fuel nozzle assembly in accordance with claim 1, wherein each of said plurality of fasteners are concentrically aligned with each of said plurality of openings when each of said plurality of fasteners are coupled to said tube assembly.

3. A fuel nozzle assembly in accordance with claim 1, wherein each of said plurality of fasteners comprises an exterior portion, an interior portion comprising a channel defined therein, and a plurality of fastener openings that extend from said exterior portion to said channel.

4. A fuel nozzle assembly in accordance with claim 1, further comprising an annular attachment plate removably coupled to said tube assembly, wherein each of said plurality of fasteners are coupled directly to said attachment plate and said attachment plate.

5. A fuel nozzle assembly in accordance with claim 1, wherein said plurality of fasteners extend radially outwardly from said tube assembly.

6. A fuel nozzle assembly in accordance with claim 1, further comprising a plurality of coupling portions coupled to said tube assembly, wherein each of said plurality of coupling portions is configured to couple one of said plurality of fasteners to said tube assembly.

7. A fuel nozzle assembly in accordance with claim 6, wherein each of said plurality of coupling portions is configured to receive one of said plurality of fasteners via a snap-fit engagement.

8. A fuel nozzle assembly in accordance with claim 6, wherein each of said plurality of fasteners comprises an end portion comprising a groove and each of said plurality of coupling portions are configured to receive said groove therein.

9. A turbine engine comprising:
a compressor;
a combustion assembly coupled to said compressor, wherein said combustion assembly comprises at least one combustor;
at least one fuel nozzle assembly coupled within said at least one combustor, said at least one fuel nozzle assembly comprises:
a tube assembly comprising a plurality of openings, wherein said tube assembly is configured to channel at least a first type of fuel through said turbine engine; and
a plurality of fasteners removably coupled to said tube assembly such that each of said plurality of fasteners are severally removable from said tube assembly to enable a plurality of different types of fuel to be channeled through said turbine engine for operation of said turbine engine.

10. A turbine engine in accordance with claim 9, wherein each of said plurality of fasteners are concentrically aligned with each of said plurality of openings when each of said plurality of fasteners are coupled to said tube assembly.

11. A turbine engine in accordance with claim 9, wherein each of said plurality of fasteners comprises an exterior portion, an interior portion comprising a channel defined therein, and a plurality of fastener openings that extend from said exterior portion to said channel.

12. A turbine engine in accordance with claim 9, wherein said at least one fuel nozzle assembly further comprises an annular attachment plate removably coupled to said tube assembly, wherein each of said plurality of fasteners are coupled directly to said attachment plate.

13. A turbine engine in accordance with claim 9, wherein said plurality of fasteners extend radially outwardly from said tube assembly.

14. A turbine engine in accordance with claim 9, wherein said at least one fuel nozzle assembly further comprises a plurality of coupling portions coupled to said tube assembly, each of said plurality of coupling portions are configured to couple one of said plurality of fasteners to said tube assembly.

15. A turbine engine in accordance with claim 14, wherein each of said plurality of coupling portions are configured to receive one of said plurality of fasteners via a snap-fit engagement.

16. A turbine engine in accordance with claim 14, wherein each of said plurality of fasteners comprises an end portion comprising a groove and each of said plurality of coupling portions are configured to receive said groove therein.

17. A method of assembling a fuel nozzle assembly for use with a turbine engine, said method comprising:
providing a tube assembly that includes a plurality of openings, wherein the tube assembly is configured to channel at least a first type of fuel through the turbine engine;
coupling a plurality of fasteners to the tube assembly to enable the first type of fuel to be channeled through the turbine engine; and
removing each of the plurality of fasteners from the tube assembly to enable a plurality of different types of fuel to be channeled through the turbine engine for operation of the turbine engine.

18. A method in accordance with claim 17, wherein coupling a plurality of fasteners to the tube assembly further comprises aligning one of the plurality of fasteners concentrically with each of the plurality of openings.

19. A method in accordance with claim 17, wherein coupling a plurality of fasteners to the tube assembly further comprises coupling each of the plurality of fasteners directly to an attachment plate that is removably coupled to the tube assembly.

20. A method in accordance with claim 17, wherein coupling a plurality of fasteners to the tube assembly further comprises coupling each of the plurality of fasteners directly to a coupling portion that is coupled to the tube assembly.
